(19) United States
(12) Patent Application Publication
(10) Pub. No.: US 2026/0306229 A1
(43) Pub. Date: Oct. 8, 2026

(54) BRUSH HEAD ASSEMBLY, TRANSMISSION STRUCTURE, AND ORAL CLEANING DEVICE

(71) Applicant: JIXI YANG, Dongguan City (CN)

(72) Inventor: JIXI YANG, Dongguan City (CN)

(21) Appl. No.: 19/710,344

(22) Filed: Jun. 16, 2026

Related U.S. Application Data
(63) Continuation-in-part of application No. 19/278,562, filed on Jul. 23, 2025, now Pat. No. 12,685,625.
(63) Continuation of application No. PCT/CN2024/119455, filed on Sep. 18, 2024.

(30) Foreign Application Priority Data
Nov. 30, 2023 (CN) 202323256975.4
Feb. 6, 2024 (CN) 202420285135.6

(51) Int. Cl. A61C 17/26; A46B 13/00; A46B 13/02; H02K 33/18

(52) U.S. Cl. CPC A61C 17/26; A46B 13/008; A46B 13/02; H02K 33/18

(57) ABSTRACT

A transmission structure for an oral cleaning device includes: a brush head assembly having an outer side configured for connection to a functional element and an inner side provided with a movable disk, the movable disk being provided with a mating area offset from a center of the brush head assembly and a rotating shaft located at the center of the brush head assembly; and a motion-transmitting member including an input end connected to a transmission mechanism of the oral cleaning device and an output end adapted to the mating area, the output end being eccentrically arranged relative to a longitudinal axis of the input end; when the transmission mechanism drives the motion-transmitting member, the output end reciprocates with a variable diameter relative to a center of the movable disk, and the mating area drives the brush head assembly to oscillate reciprocally.

### CROSS-REFERENCE TO RELATED APPLICATIONS

The present application is a continuation-in-part of U.S. patent application Ser. No. 19/278,562, filed on Jul. 23, 2025, entitled “ELECTRIC ORAL CLEANING TOOL,” which claims the benefit of PCT Application No. PCT/CN2024/119455, filed on Sep. 18, 2024, which claims priority to Chinese Patent Application No. 202323256975.4, filed on Nov. 30, 2023, and Chinese Patent Application No. 202420285135.6, filed on Feb. 6, 2024. The entire contents of the foregoing applications are hereby incorporated by reference herein in their entirety.

### TECHNICAL FIELD

This application relates to the technical field of oral cleaning devices, and in particular to a brush head assembly, a transmission structure, and an oral cleaning device.

### BACKGROUND

Electric toothbrushes, as a common oral cleaning device nowadays, are mainly divided into sonic toothbrushes and rotary toothbrushes. The sonic brush heads mainly use left and right high-frequency oscillation to achieve vibration cleaning, while the rotary brush heads mainly use left and right high-frequency rotation to achieve efficient cleaning with better cleaning results.

For the common rotary electric toothbrushes on the market, power is transmitted to the handle through a transmission mechanism that oscillates eccentrically from side to side, and then from the handle to the brush head through multiple parts, requiring multiple structural assemblies and coordination, which not only increases the difficulty of assembly and production, but also easily leads to poor consistency in the amplitude of the brush head. After long-term use, the gap between the parts increases, which may further lead to louder noise and attenuation of the amplitude, affecting the cleaning effect and user experience.

### SUMMARY OF THE DISCLOSURE

In view of this, the present disclosure provides a brush head assembly, a transmission structure, and an oral cleaning device, to solve the problems of poor consistency and affected cleaning effect and user experience after prolonged use of electric toothbrushes in the related art.

To achieve one or some or all of the above purposes or other purposes, the present disclosure proposes a brush head assembly for an oral cleaning device, comprising an outer side configured for connection to a functional element and an inner side provided with a movable disk, wherein the movable disk is provided with a mating area offset from a center of the brush head assembly and a rotating shaft located at the center of the brush head assembly, and the mating area is an elliptical groove or a fixing rod arranged on the movable disk.

Further, the movable disk is provided with a longitudinally-opened receiving slot.

To achieve one or some or all of the above purposes or other purposes, the present disclosure further proposes a transmission structure for an oral cleaning device, including:
a brush head assembly having an outer side configured for connection to a functional element and an inner side provided with a movable disk, the movable disk being provided with a mating area offset from a center of the brush head assembly and a rotating shaft located at the center of the brush head assembly; and
a motion-transmitting member including an input end connected to a transmission mechanism of the oral cleaning device and an output end adapted to the mating area, the output end being eccentrically arranged relative to a longitudinal axis of the input end;
wherein, when the transmission mechanism drives the motion-transmitting member, the output end reciprocates with a variable diameter relative to a center of the movable disk, and the mating area drives the brush head assembly to oscillate reciprocally.

Further, the mating area is an elliptical groove, the output end is a guide rod, and the guide rod is adaptively connected to the elliptical groove.

Further, the mating area is a fixing rod arranged on the movable disk, the output end is a pivot hole, and the fixing rod is adaptively connected to the pivot hole.

Further, the movable disk has a cam shape, the mating area is arranged at an acute-angled end of the cam shape, and a side of a rounded end of the cam shape is provided with a longitudinally-opened receiving slot.

Further, a magnetic attraction force of the input end of the motion-transmitting member is between 3.5 N and 35 N.

Further, a length of the elliptical groove is 2 mm, and a distance between the guide rod and the center of the brush head assembly is 2 mm to 4 mm.

Further, a maximum longitudinal reciprocating travel of the motion-transmitting member is 1-5 mm, and a rotation angle of the brush head assembly is between −38° and 38°.

Further, at least the input end of the motion-transmitting member is integrally formed.

To achieve one or some or all of the above purposes or other purposes, the present disclosure further proposes an oral cleaning device, including: a housing, a motion-transmitting member, and a brush head assembly, the motion-transmitting member being arranged inside the housing;
the brush head assembly is rotatably connected to an end of the housing, a functional element is arranged on one side of the brush head assembly, a movable disk is arranged on another side of the brush head assembly, the movable disk is provided with a mating area offset from a center of the brush head assembly; the motion-transmitting member including an input end connected to a transmission mechanism of the oral cleaning device and an output end adapted to a mating area, the output end being eccentrically arranged relative to a longitudinal axis of the input end; the output end of the motion-transmitting member is matched with the mating area, and when the output end reciprocates longitudinally, the mating area and the brush head assembly are driven to oscillate reciprocally.

Further, the input end is integrally formed, the output end is a guide rod or a pivot hole adapted to the mating area, and a connecting rod connects the guide rod or the pivot hole with the input end; a shortest distance between a center point of the guide rod and a central axis of the input end is 1.5-4.5 mm, and a distance between the guide rod and the center of the brush head assembly is 2 mm-4 mm.

Further, the oral cleaning device further includes a handle, the handle being connected to a lower end of the housing, a transmission mechanism and a motor being arranged inside the handle, an output end of the motor being connected to an input end of the transmission mechanism, a battery being further arranged inside the handle, the battery being disposed at a lower end of the motor and electrically connected to the motor;
the transmission mechanism includes a driving gear, a driven gear, and a transmission rod, the driving gear is sleeved on an output shaft of the motor, the motor is fixedly connected to an inner wall of the handle, the output shaft of the motor is arranged upward along a length direction of the handle, the driving gear is horizontally and rotatably connected to the output shaft of the motor, the driven gear is a bevel gear, the driven gear and the driving gear are perpendicular to each other, the driven gear meshes with the driving gear, the transmission rod is transmission-connected to the driven gear, the motor drives the driving gear to rotate horizontally and drives the driven gear to rotate vertically, and the driven gear drives the transmission rod to reciprocate up and down.

Further, the transmission mechanism has a magnetic connecting portion, and a magnetic attraction force between the input end of the motion-transmitting member and the magnetic connecting portion is between 3.5 N and 35 N.

Further, the oral cleaning device further includes a handle, the handle being connected to a lower end of the housing, a linear motor assembly and an output shaft being arranged inside the handle, a battery being further arranged inside the handle, the battery being disposed at a lower end of the linear motor assembly and electrically connected to the linear motor assembly;
the linear motor assembly includes:
a motor housing;
a permanent magnet assembly, the permanent magnet assembly being at least two permanent magnets spaced apart on the motor housing, the permanent magnet assembly serving as a stator;
an armature, an iron core of the armature having two sets of coils connected in series and arranged along an axial direction, both ends of the iron core being connected to the motor housing via leaf springs and positioned above the permanent magnet assembly, the armature serving as a mover;
wherein the transmission mechanism is the output shaft connected to the armature; a gap between the permanent magnets and comb-tooth portions of the iron core of the armature is set between 0.1 mm and 0.8 mm.

Further, the oral cleaning device further includes: an auxiliary module formed by a counterweight having both ends connected to the motor housing via leaf springs.

Further, a main body of the iron core of the armature is formed by mixed stacking of 4-tooth comb-shaped laminations and 6-tooth comb-shaped laminations, two sets of coils being wound around two central teeth; laminations for connecting the leaf springs are 6-tooth comb-shaped, with two outer teeth on opposite sides being shorter, and at least a portion of the outer surfaces of the two outer teeth on opposite sides being provided with connecting lugs.

Further, in the 6-tooth comb-shaped lamination, tooth shoes of a second tooth and a fifth tooth are equal to half a width dimension of tooth shoes of two middle teeth.

Further, the permanent magnet assembly comprises three permanent magnets spaced apart on the motor housing, and at an initial position, a first magnet is located between a first tooth and a second tooth of the 4-tooth comb-shaped lamination, a second magnet is located between the second tooth and a third tooth of the 4-tooth comb-shaped lamination, and a third magnet is located between the third tooth and a fourth tooth of the 4-tooth comb-shaped lamination.

Further, a back side of the permanent magnet assembly is provided with an iron piece assembly, the iron piece assembly being fixed to the motor housing.

Further, the leaf spring has a central end and an outer end, and spirals at least one turn from the central end to the outer end, the outer end having at least two outer connecting ends forming an angle of 80-100 degrees with respect to a center of the spiral, and when the leaf spring is connected to the motor housing, the at least two outer connecting ends are respectively connected to a bottom wall and a side wall of the motor housing.

Further, the permanent magnet assembly comprises three permanent magnets spaced apart on the motor housing, and the number of the outer connecting ends is two.

Further, the motor housing is trough-shaped, with a front end provided with a through hole for a drive shaft to pass through and connect to the leaf spring.

Implementation of the embodiments of the present disclosure will have the following beneficial effects:

With the transmission structure provided by the present disclosure, when the output end of the motion-transmitting member reciprocates longitudinally, it can drive the mating area to move. The transmission mechanism transmits power to the movable disk via the motion-transmitting member. The entire transmission process requires few parts and involves less energy loss. Even after long-term use, the noise and swing range will not be greatly affected.

### BRIEF DESCRIPTION OF THE DRAWINGS

In order to more clearly illustrate the embodiments of the present disclosure or the technical solutions in the related art, the following provides a brief description of the drawings for use in the description of the embodiments or the related art. Obviously, the drawings in the following description are just some embodiments of the present disclosure. For those skilled in the art, without investing creative effort, other drawings can be obtained based on these drawings.

Wherein:

FIG. 1 is a structural schematic view of a brush head assembly according to an embodiment of the present disclosure;

FIG. 2 is a side view of an oral cleaning device according to an embodiment of the present disclosure;

FIG. 3 is a cross-sectional view along A-A in FIG. 2;

FIG. 4 is an enlarged view of area B in FIG. 3;

FIG. 5 is a cross-sectional view of another cross-section of an oral cleaning device according to an embodiment of the present disclosure;

FIG. 6 is a structural schematic view of an oral cleaning device, according to an embodiment of the present disclosure, where a housing is not illustrated;

FIG. 7 is a schematic diagram of a working state of an oral cleaning device, according to an embodiment of the present disclosure, where a housing is not illustrated;

FIG. 8 is a structural schematic view of a housing of an oral cleaning device according to another embodiment of the present disclosure;

FIG. 9 is a structural schematic view of an oral cleaning device, according to another embodiment of the present disclosure, where a housing is not illustrated;

FIG. 10 is a structural schematic view of an oral cleaning device, according to yet another embodiment of the present disclosure, where a housing is not illustrated;

FIG. 11 is a cross-sectional view of an oral cleaning device according to an embodiment of the present disclosure;

FIG. 12 is a structural schematic view of a linear motor assembly according to an embodiment of the present disclosure;

FIG. 13 is a structural schematic view of a linear motor assembly according to another embodiment of the present disclosure;

FIG. 14 is a structural schematic view of an armature and an auxiliary module according to an embodiment of the present disclosure;

FIG. 15 is a schematic view of an installation structure of a permanent magnet assembly according to an embodiment of the present disclosure;

FIG. 16 is a structural schematic view of a leaf spring according to an embodiment of the present disclosure;

FIG. 17 is a structural schematic view of a 4-tooth comb-shaped lamination according to an embodiment of the present disclosure;

FIG. 18 is a structural schematic view of a 6-tooth comb-shaped lamination according to an embodiment of the present disclosure;

FIG. 19 is a structural schematic view of a 6-tooth comb-shaped lamination according to another embodiment of the present disclosure;

FIG. 20 is a structural cross-sectional view of a linear motor assembly according to an embodiment of the present disclosure;

FIG. 21 is a schematic view of an installation structure of an iron piece assembly according to an embodiment of the present disclosure;

FIG. 22 is a structural schematic view of a linear motor assembly according to another embodiment of the present disclosure;

FIG. 23 is another perspective view of FIG. 22;

FIG. 24 is a structural cross-sectional view of a linear motor assembly according to an embodiment of the present disclosure.

### REFERENCE NUMERALS

1, housing; 12, limit groove; 13, guide ring;
2, motion-transmitting member; 21, guide rod; 211, extension post; 22, pivot hole;
3, brush head assembly; 31, functional element; 32, movable disk; 321, elliptical groove; 322, receiving slot; 33, limit structure; 34, rotating shaft; 35, fixing rod; 4, handle;
5, transmission mechanism; 51, driving gear; 52, driven gear; 53, transmission rod; 54, sleeve; 55, eccentric post; 56, rotating shaft;
6, motor; 101, motor housing; 102, permanent magnet assembly; 103, armature; 1031, iron core; 10311, 4-tooth comb-shaped lamination; 10312, 6-tooth comb-shaped lamination; 103121, connecting lug; 1032, coil; 104, leaf spring; 1041, central end; 1042, outer end; 10421, outer connecting end; 105, auxiliary module; 1051, additional counterweight; 106, drive shaft; 107, iron piece assembly;
7, battery.

### DETAILED DESCRIPTION

Unless otherwise defined, all technical and scientific terms used herein shall have the same meaning as commonly understood by those skilled in the art. The terms used herein in the description of the present disclosure are for the sole purpose of describing specific embodiments and are not intended to limit the present disclosure. The terms “including” and “having” and any variations thereof in the description, claims, and aforementioned description of the drawings of the present disclosure are intended to cover non-exclusive inclusion. The terms “first,” “second,” etc., in the description and claims of the present disclosure or in the above-mentioned drawings are intended to distinguish different objects, not to describe a specific order.

References herein to “embodiments” mean that the particular feature, structure, or characteristic described in conjunction with an embodiment may be included in at least one embodiment of the present disclosure. The occurrence of the phrase at various locations in the description does not necessarily refer to the same embodiment, nor is it a separate or alternative embodiment that is mutually exclusive from other embodiments. It is expressly and implicitly understood by those skilled in the art that the embodiments described herein can be combined with other embodiments.

In order to better enable those skilled in the art to understand the present disclosure, the following will clearly and completely describe the technical solution of the embodiments of the present disclosure in conjunction with the accompanying drawings.

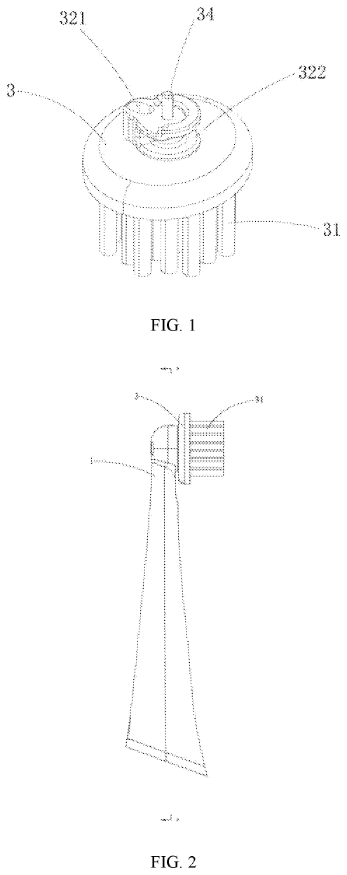

Referring to FIG. 1, the present disclosure proposes a brush head assembly for an oral cleaning device. An outer side of the brush head assembly is configured for connection to a functional element, and an inner side is provided with a movable disk. The movable disk is provided with a mating area offset from a center of the brush head assembly and a rotating shaft located at the center of the brush head assembly. The mating area is an elliptical groove or a fixing rod arranged on the movable disk. The movable disk is provided with a longitudinally-opened receiving slot.

In the present embodiment, the brush head assembly may be a circular plate. Taking an electric toothbrush as an example of the oral cleaning device, the outer side is the side connected to bristles, and the inner side is the opposite side, in which case the bristles are the aforementioned functional element. For further details, reference is made to the subsequent embodiments. The movable disk is provided with a mating area offset from the center of the brush head assembly and a rotating shaft located at the center of the brush head assembly. The rotating shaft is configured to position the brush head assembly onto the housing of the electric toothbrush, as detailed in the subsequent embodiments. The mating area offset from the center of the brush head assembly may be configured to cooperate with the motion-transmitting member, enabling the brush head assembly to oscillate reciprocally via the motion-transmitting member.

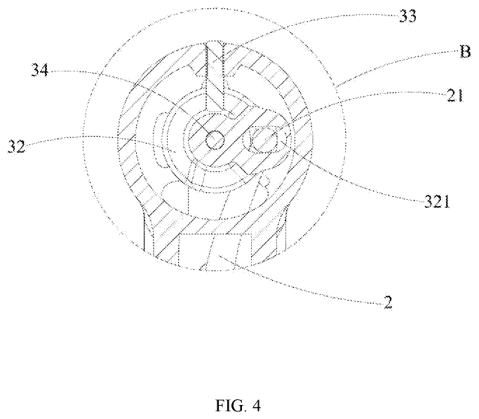

Referring to FIGS. 4, 6, 7, and 9, the present disclosure further proposes a transmission structure for an oral cleaning device, including:
a brush head assembly having an outer side configured for connection to a functional element and an inner side provided with a movable disk, the movable disk being provided with a mating area offset from a center of the brush head assembly and a rotating shaft located at the center of the brush head assembly; and
a motion-transmitting member including an input end connected to a transmission mechanism of the oral cleaning device and an output end adapted to the mating area, the output end being eccentrically arranged relative to a longitudinal axis of the input end;
wherein, when the transmission mechanism drives the motion-transmitting member, the output end reciprocates with a variable diameter relative to a center of the movable disk, and the mating area drives the brush head assembly to oscillate reciprocally. The variable diameter refers to the fact that the distance between the output end and the center of the movable disk changes during the reciprocating motion.

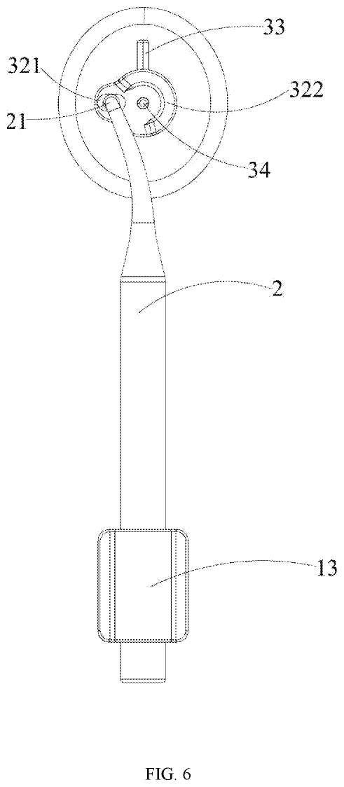

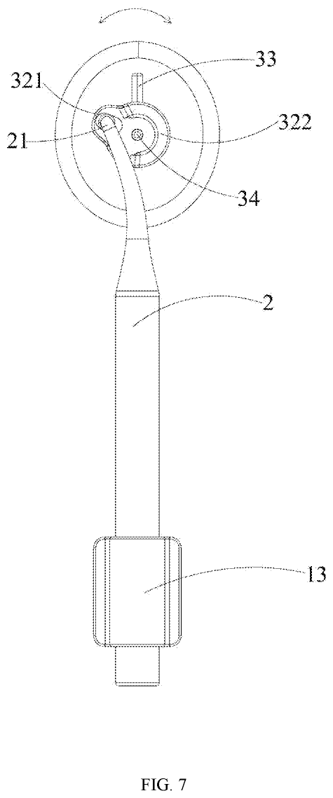

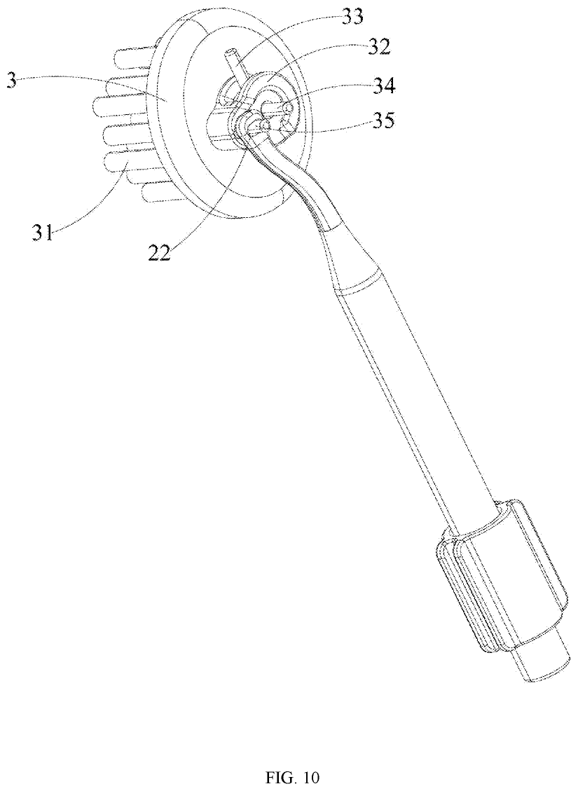

In the present embodiment, the brush head assembly has the same structure as described in the above embodiment. The motion-transmitting member is as shown in FIG. 6 or FIG. 7, and may also be as shown in FIG. 10. That is, the mating area is an elliptical groove, the output end is a guide rod, and the guide rod is adaptively connected to the elliptical groove. Alternatively, the mating area is a fixing rod arranged on the movable disk, the output end is a pivot hole, and the fixing rod is adaptively connected to the pivot hole. For further details, reference is made to the embodiment of the oral cleaning device described below.

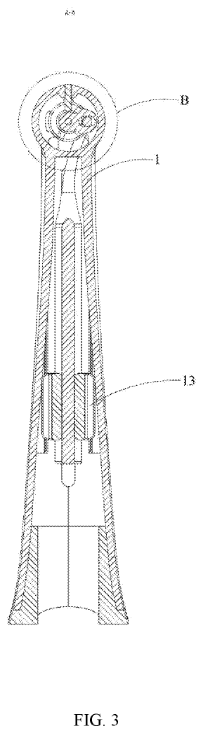

Referring to FIGS. 2 to 7, the present disclosure proposes an oral cleaning device, including a housing 1, a motion-transmitting member 2, and a brush head assembly 3.

The brush head assembly 3 is rotatably connected to an end of the housing 1, and a functional element 31 is arranged on one side of the brush head assembly 3. The functional element 31 may include multiple groups of bristles as shown in FIG. 2, or it may be other components, such as a tongue coating cleaner or a soft rubber cleaner. A movable disk 32 is arranged on another side of the brush head assembly 3. The movable disk 32 has a mating area that is offset from the center of the brush head assembly 3. The output end of the motion-transmitting member 2 is matched with the mating area, and when the output end reciprocates longitudinally, it drives the mating area and the brush head assembly 3 to oscillate reciprocally.

The motion-transmitting member 2 is arranged inside the housing 1. The input end of the motion-transmitting member 2 is configured to be connected to a transmission mechanism and is cylindrical or substantially cylindrical, such as elliptical cylindrical. The input end extends into a cavity of the housing. At least the input end is integrally formed. The output end of the motion-transmitting member 2 is an end close to the brush head assembly 3, including a guide rod 21 or a pivot hole 22 adapted to the mating area, and a connecting rod for connecting the guide rod 21 or the pivot hole 22 with the input end. The shortest distance between a center point of the guide rod 21 and a central axis of the input end is 1.5-4.5 mm, and the distance between the guide rod and the center of the brush head assembly is 2 mm-4 mm. In addition, the output end and the input end may be integrally formed by bending, and an extension post 211 may be further welded or riveted to the output end.

The transmission mechanism 5 has a magnetic connecting portion, and a magnetic attraction force between the input end of the motion-transmitting member 2 and the magnetic connecting portion is set between 3.5 N and 35 N, preferably between 3.5 N and 20 N.

When the housing 1 is inserted into a toothbrush handle, a top end of the transmission mechanism inside the toothbrush handle is connected to the motion-transmitting member 2 by magnetic attraction and drives the motion-transmitting member 2 to reciprocate longitudinally. The transmission mechanism may be an existing structure, which will not be described in detail herein. The movement trajectory of the motion-transmitting member 2 is perpendicular to the horizontal direction, such that the output end moves at a variable diameter relative to the center of the movable disk. A lower end of the motion-transmitting member 2 is arranged close to the transmission mechanism and is symmetrically arranged about a longitudinal central axis of the brush head assembly 3. An upper end of the motion-transmitting member 2 gradually deviates to one side. In the present embodiment, the mating area is an elliptical groove 321, and the upper end of the motion-transmitting member 2 is arranged with a guide rod 21, that is, a side projection of the motion-transmitting member 2 is similar to a “7” shape. The guide rod 21 is disposed in the elliptical groove 321. When the guide rod 21 reciprocates longitudinally with the motion-transmitting member 2, the guide rod 21 drives the elliptical groove 321 to rotate.

The elliptical-shaped groove 321 provides sufficient movement space for the guide rod 21. The longitudinal movement of the guide rod 21 drives the elliptical groove 321 to rotate around the central point of the brush head assembly 3. The brush head assembly 3 rotates together with the elliptical groove 321, and the direction of rotation is indicated by the arrow in FIG. 7. Taking the direction shown in FIG. 7 as an example, when the motion-transmitting member 2 moves upward, the brush head assembly 3 rotates to the right, and when the motion-transmitting member 2 moves downward, the brush head assembly 3 rotates to the left. The transmission mechanism drives the motion-transmitting member 2 to move up and down at high frequency, and the brush head assembly 3 also rotates left and right at high speed, driving the functional element 31 on the other side of the brush head assembly 3 to rotate at high speed. Taking a toothbrush as an example, the cleaning of the teeth can thus be achieved.

In another embodiment, as shown in FIG. 10, the mating area is a fixing rod 35 arranged on the movable disk, which is eccentrically arranged, and the output end is provided with a pivot hole 22. The fixing rod 35 is disposed in the pivot hole 22, which is also elliptical-shaped. When the pivot hole 22 moves longitudinally, the fixing rod 35 moves transversely in the pivot hole 22. The working principle is similar to the above embodiment and will not be repeated.

In the present embodiment, an orthographic projection of the movable disk 32 is composed of two circular segments sharing a common chord. The distance between the central point of the elliptical groove 321 and the central point of the brush head assembly 3 is equal to the distance between the central point of the brush head assembly 3 and an edge on another side of the movable disk 32. It is also possible to make the former distance slightly greater than the latter distance. The greater the former distance, when the guide rod 21 moves upward, the longer the moment arm of the upward force acting on the side wall of the elliptical groove 321, and the smaller the force required to drive the movable disk 32 to rotate, thus the more energy-saving it is. In addition, considering the size of the housing 1 and the stability of the transmission, it is preferable to make the former distance equal to the latter distance.

In the present embodiment, a rotating shaft 34 is further inserted on the movable disk 32. The rotating shaft 34 is arranged at the center of the brush head assembly 3. An end of the rotating shaft 34 abuts against the housing 1, and the rotating shaft 34 is fixed to the interior of the movable disk 32 by assembly. The movable disk 32 drives the brush head assembly 3 to rotate together around the rotating shaft 34.

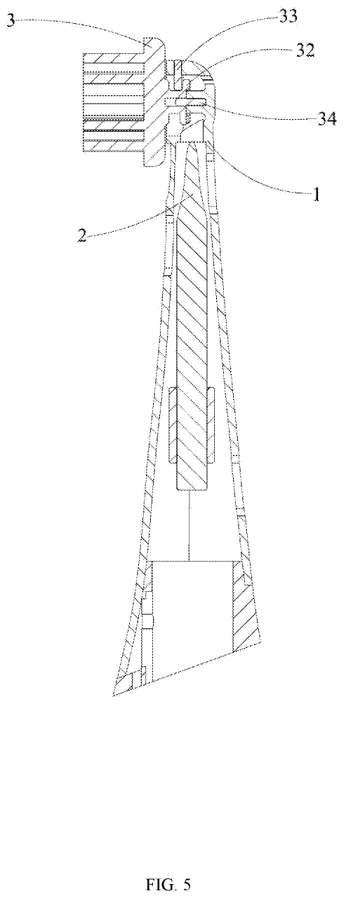

A limit structure 33 is arranged on the movable disk 32, and the limit structure 33 is configured to axially limit the brush head assembly 3. As shown in FIG. 5, the movable disk 32 defines a longitudinally-opened receiving slot 322, and the housing 1 defines a longitudinal through hole. The limit structure 33 is inserted from the through hole into the receiving slot 322 and abuts against a side wall of the receiving slot 322, and the receiving slot 322 can rotate relative to the limit structure 33. The rotating shaft 34 prevents the movable disk 32 from moving in a horizontal or vertical direction, while the limit structure 33 prevents the movable disk 32 from moving in an extension direction of the rotating shaft 34, and the movable disk 32 can only rotate in a peripheral direction. In the present embodiment, the limit structure 33 is a limiting pin.

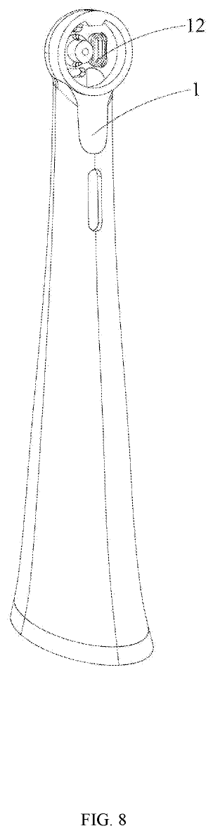

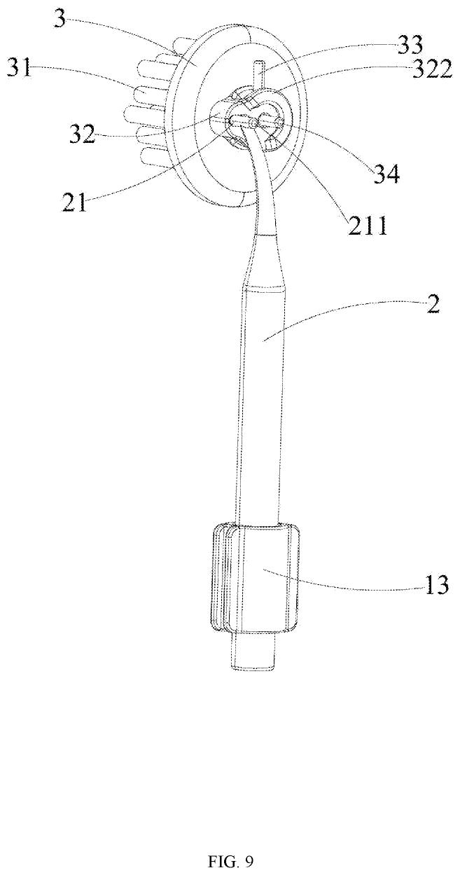

In another embodiment, as shown in FIGS. 8 and 9, the guide rod 21 extends with an extension post 211 at an end away from the brush head assembly 3, and an inner side of the housing 1 defines a limit groove 12. The extension post 211 is disposed in the limit groove 12 and is movable longitudinally in the limit groove 12. Limiting the extension post 211 via the limit groove 12 makes the motion-transmitting member 2 less prone to wobbling, such that the distance between the rotating shaft 34 and the vertical line on which the movement trajectory of the guide rod 21 lies is always fixed. In the process, the distance between the guide rod 21 and the rotating shaft 34 is a variable distance, and the maximum longitudinal travel of the motion-transmitting member 2 is 1-5 mm. Preferably, this maximum travel is 1.5 mm-3.5 mm, in which case the rotation angle of the brush head assembly 3 is between −38° and 38°, which can thoroughly clean the teeth.

In addition, a guide ring 13 is fixed to an inner wall of the housing 1, and the motion-transmitting member 2 passes through the guide ring 13 and can reciprocate longitudinally within the guide ring 13. The guide ring 13 guides and limits the motion-transmitting member 2, such that the motion-transmitting member 2 does not deviate during movement. In the present embodiment, an outer wall of the guide ring 13 is arranged with symmetrical snap-fit blocks, and the inner wall of the housing 1 defines symmetrical snap-fit grooves in corresponding positions. The snap-fit blocks are adapted to the snap-fit grooves, and after being snapped together, the position of the guide ring 13 is fixed and will not move with the movement of the motion-transmitting member 2. The inner diameter of the guide ring 13 is consistent with the outer diameter of the input end of the motion-transmitting member 2, which results in less friction and less loss during transmission, while preventing the motion-transmitting member 2 from deflecting, thus having less impact on use.

In the present embodiment, the motion-transmitting member 2 is integrally formed. The end of the motion-transmitting member 2 away from the brush head assembly 3 has a horizontal end face, which may be adapted to a transmission mechanism. The motion-transmitting member 2 is made of magnetizable metal at least at the input end. In another embodiment, the motion-transmitting member 2 is made of a plastic material mixed with magnetic powder at least at the input end. That is, the input end of the motion-transmitting member 2 can be connected and fixed to the output end of the transmission mechanism by magnetic attraction.

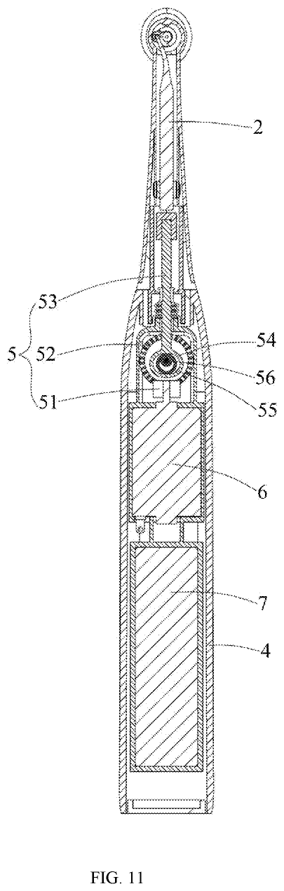

Referring to FIG. 11, the oral cleaning device further includes a handle 4. The handle 4 is connected to a lower end of the housing 1. The handle 4 is arranged with a transmission mechanism 5 and a motor 6. An output end of the motor 6 is connected to an input end of the transmission mechanism 5. A battery 7 is further arranged inside the handle 4. The battery 7 is disposed at a lower end of the motor 6 and electrically connected to the motor 6. Specifically, the transmission mechanism 5 includes a driving gear 51, a driven gear 52, and a transmission rod 53. The driving gear 51 is sleeved on an output shaft of the motor 6 and rotates together with the output shaft of the motor 6. The motor 6 is fixedly connected to an inner wall of the handle 4. The output shaft of the motor 6 is arranged in the same direction as the handle 4, specifically, arranged upward along the length direction of the handle 4. The driving gear 51 is horizontally and rotatably connected to the output shaft of the motor 6. The driven gear 52 is a bevel gear, and the driven gear 52 and the driving gear 51 are perpendicular to each other. The driven gear 52 meshes with the driving gear 51, converting the horizontal rotation into vertical rotation. The transmission rod 53 is transmission-connected to the driven gear 52. The motor 6 drives the driving gear 51 to rotate horizontally, which drives the driven gear 52 to rotate vertically, and then the driven gear 52 drives the transmission rod 53 to reciprocate up and down.

Specifically, a lower end of the transmission rod 53 is arranged with a sleeve 54, and the driven gear 52 is arranged with an eccentric post 55. The sleeve 54 is sleeve-fitted with the eccentric post 55. The driven gear 52 is arranged with a transverse rotating shaft 56. The rotating shaft 56 penetrates along the axial direction of the eccentric post 55 and passes through a bottom of the sleeve 54. Both ends of the rotating shaft 56 are rotatably connected to the inner wall of the handle 4 to support the rotation of the driven gear 52. The driven gear 52 drives the eccentric post 55 to rotate around the rotating shaft 56, and the sleeve 54 oscillates up and down with the rotation of the eccentric post 55, which in turn drives the transmission rod 53 as a whole to reciprocate up and down. An upper end of the transmission rod 53 is arranged with a magnetic connecting portion for magnetic connection with the motion-transmitting member 2. Since an input end of the motion-transmitting member 2 is made of magnetizable material, the transmission rod 53 can ultimately drive the functional element 31 to oscillate and clean the user's oral cavity.

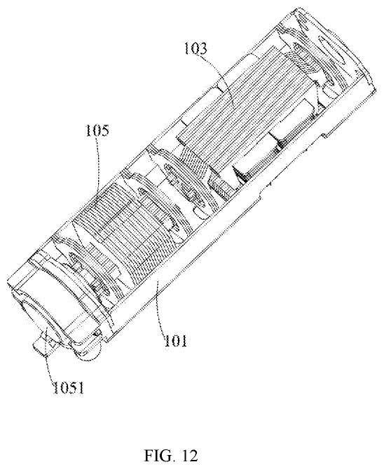

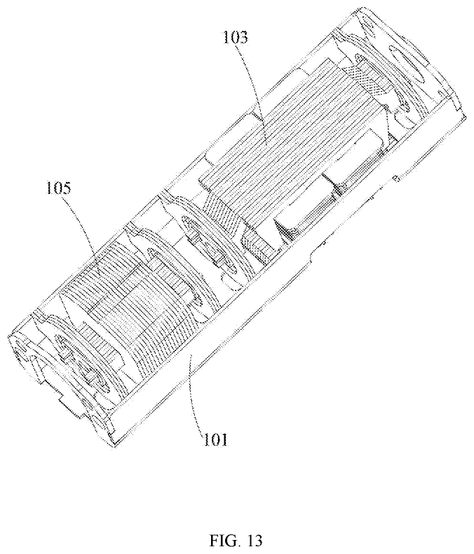

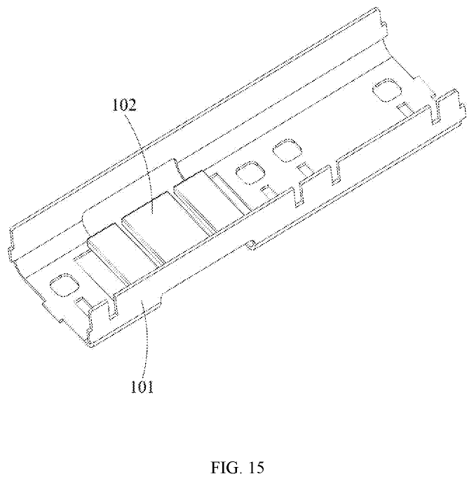

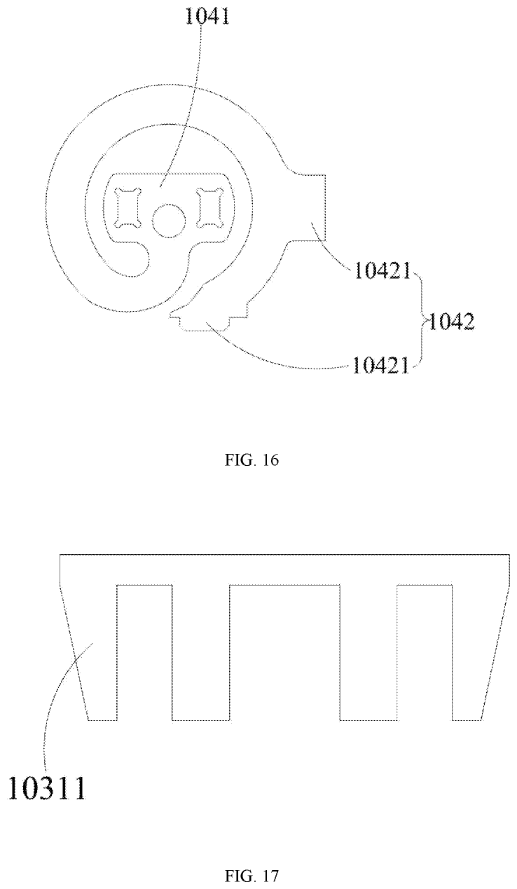

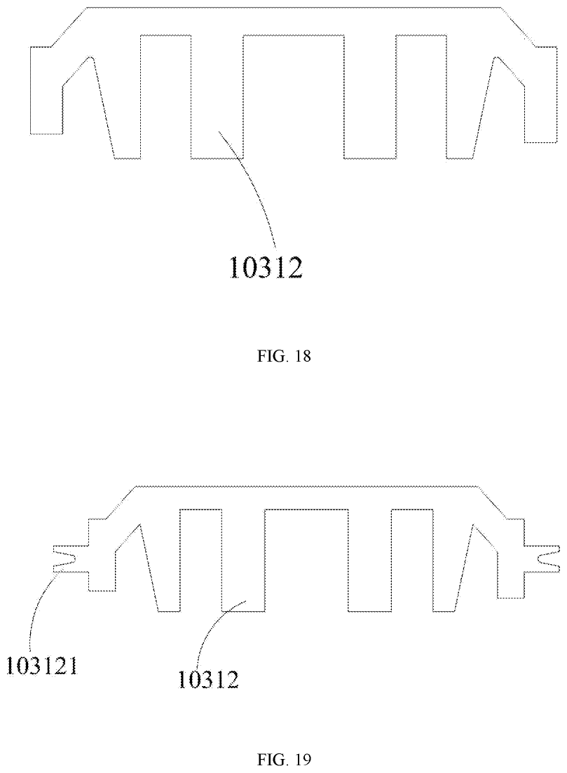

Referring to FIGS. 12 to 24, the oral cleaning device further includes a handle 4. The handle 4 is connected to a lower end of the housing 1. The handle 4 is arranged with a linear motor assembly. The linear motor assembly includes a linear motor and an output shaft. In the present embodiment, the transmission mechanism is the aforementioned output shaft. A battery 7 is further arranged inside the handle 4. The battery 7 is disposed at a lower end of the motor and electrically connected to the linear motor assembly. Specifically, the linear motor assembly includes: a motor housing 101; a permanent magnet assembly 102, the permanent magnet assembly 102 being at least two permanent magnets spaced apart on the motor housing 101, the permanent magnet assembly 102 serving as a stator; an armature 103, an iron core 1031 of the armature 103 having two sets of coils 1032 connected in series and arranged along an axial direction, both ends of the iron core 1031 being connected to the motor housing 101 via leaf springs 104 and positioned above the permanent magnet assembly 102, the armature 103 serving as a mover; a gap between the permanent magnets and comb-tooth portions of the iron core 1031 of the armature 103 is set between 0.1 mm and 0.8 mm.

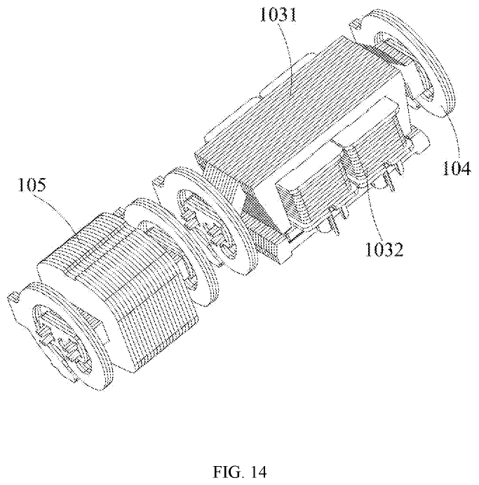

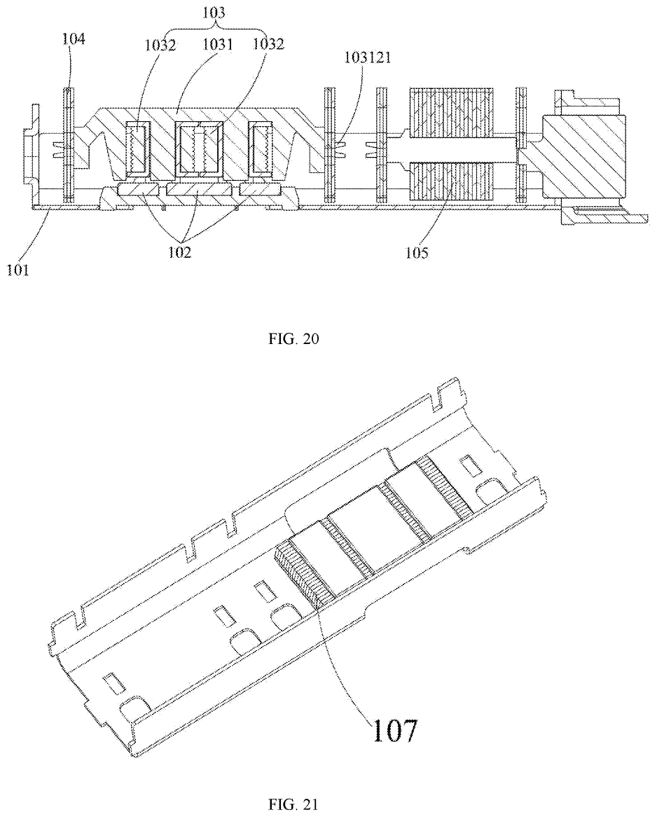

In the present embodiment, the motor housing 101 may be a trough-shaped motor housing 101. The bottom may be provided with snap-fit structures for engaging the permanent magnets, or the permanent magnets may be directly adhered or fixed by other conventional means. The aforementioned axial direction refers to the direction in which the mover moves during operation, i.e., the length direction of the drive shaft 106. The two sets of coils 1032 are arranged along the axial direction on the iron core 1031 of the armature 103, meaning that two sets of coils 1032 are arranged on the iron core 1031 and these two sets of coils 1032 are sequentially arranged in the axial direction, as shown in FIGS. 14 and 20. Since the armature 103 of the linear motor assembly serves as the mover and the permanent magnets serve as the stator, the permanent magnets can be directly arranged on the motor housing 101. Compared to existing linear motor assemblies, no oscillation structure for bearing the permanent magnets is needed, so the overall volume can be made smaller. The aforementioned leaf springs 104 may be single leaf springs 104 or multiple stacked leaf springs 104. In addition, since the armature 103 serves as the mover, extended structures need to be provided at both ends of the iron core 1031 of the armature 103 to connect the leaf springs 104. If connecting shafts are directly extended from the iron core 1031 of the armature 103, the magnetic field generated by the coils 1032 would be dispersed toward the connecting shafts, weakening the magnetic force of the coils 1032 on the permanent magnets, resulting in reduced efficiency and poor battery life. However, in the present embodiment, by providing two sets of coils 1032, even with connecting shafts directly extended from the iron core 1031 of the armature 103, the magnetic field at the adjacent portion of the two sets of coils 1032 is not weakened, and the degree of magnetic force reduction is greatly improved, which can better solve the aforementioned problem of poor battery life.

It is worth noting that, under the same power supply, when two coils 1032 are connected in series, compared to a single coil 1032, the current is halved while the total magnetomotive force (IN) remains unchanged, so the electromagnetic force is the same as that of a single coil 1032. The following provides a more detailed explanation:

### 1. For a Single Coil 1032:

Load current:

$${I}_{single} = \frac{{Ud}^{4}}{ρ L ( D {2}^{2} - D {1}^{2} )} \times {10}^{3} ( A )$$

Electromagnetic force:

$${F}_{single} = \frac{{μ}_{0} {S}_{0}}{8} {( \frac{{d}^{2} U}{ρ ( D 2 + D 1 ) δ} )}^{2} \times \text{?} ( N )$$

$$\text{?} \text{indicates text missing or illegible when filed}$$

### 2. For Two Coils 1032 Connected in Series:

Total resistance:

$${R}_{series} = 2 {R}_{single} = 2 \cdot ρ \frac{L ( D {2}^{2} - D {1}^{2} )}{{d}^{4}} \times {10}^{- 3} ( Ω )$$

Load current (current halved):

$${I}_{series} = \frac{U}{{R}_{series}} = \frac{{Ud}^{4}}{2 ρ L ( D {2}^{2} - D {1}^{2} )} \times {10}^{3} = \frac{{I}_{single}}{2} ( A )$$

Total magnetomotive force (IN unchanged):

$${( IN )}_{series} = {I}_{series} \cdot 2 N = \frac{{I}_{single}}{2} \cdot 2 N = {I}_{single} \cdot N = {( IN )}_{single}$$

Electromagnetic force (same as single coil 1032): Fₛₑᵣᵢₑₛ=F_{single}

Where ρ is the resistivity; L is the winding width; U is the voltage; D2 is the winding outer diameter; D1 is the winding inner diameter; d is the enameled wire diameter.

From the above calculation, it can be seen that under the same voltage, when two coils 1032 are connected in series, the load current is half that of a single coil 1032, and the electromagnetic force is the same as that of a single coil 1032. Therefore, under the same power supply, two series-connected coils 1032 have increased resistance and decreased current, with the output power remaining unchanged and power consumption reduced, thereby improving battery life. Under the condition of maintaining the same current, since the armature 103 has dual coils 1032, the output power is increased and the cleaning force is enhanced.

In some embodiments, the linear motor assembly further includes:
an auxiliary module 105 formed by a counterweight having both ends connected to the motor housing 101 via leaf springs 104.

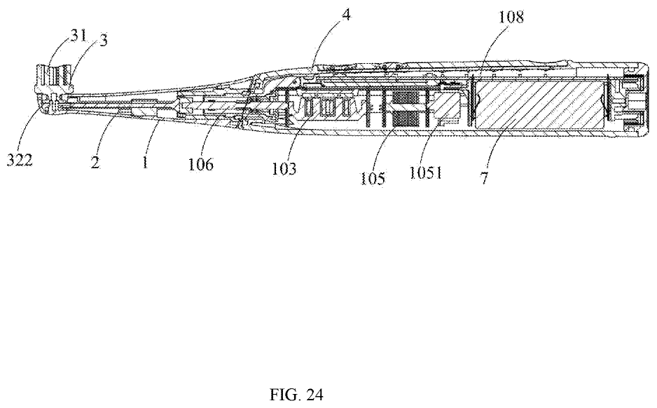

In the present embodiment, the overall structure and arrangement of the auxiliary module 105 is similar to that of the armature 103, except that the auxiliary module 105 does not include coils 1032, as shown in FIGS. 12 and 24. The function of the auxiliary module 105 is to reduce the influence of the linear motor assembly on the vibration of the housing through resonance, thereby improving the user experience. Preferably, the mass of the counterweight is as close as possible to the mass of the armature 103. In addition, the auxiliary module 105 may further include an additional counterweight 1051, as shown in FIG. 12 or FIG. 24. The additional counterweight can adjust the balance to accommodate different frequencies.

In some embodiments, a main body of the iron core 1031 of the armature 103 is formed by mixed stacking of 4-tooth comb-shaped laminations 10311 and 6-tooth comb-shaped laminations 10312. Two sets of coils 1032 are wound around two central teeth. The laminations for connecting the leaf springs 104 are 6-tooth comb-shaped, with two outer teeth on opposite sides being shorter, and at least a portion of the outer surfaces of the two outer teeth on opposite sides being provided with connecting lugs 103121.

In the present embodiment, the two sets of coils 1032 are wound around two central teeth, with specific positions as shown in FIGS. 14 and 20. As mentioned above, providing connecting shafts on the iron core 1031 of the armature 103 would somewhat affect the magnetic field generated by the coils 1032. In the present embodiment, the iron core is formed by mixed stacking of 4-tooth comb-shaped laminations 10311 and 6-tooth comb-shaped laminations 10312. As shown in FIG. 14, compared to a configuration formed entirely by stacking 6-tooth comb-shaped laminations 10312, the connecting shafts are smaller, and the aforementioned magnetic field impact is reduced.

In some embodiments, in the 6-tooth comb-shaped lamination 10312, tooth shoes of a second tooth and a fifth tooth are equal to half a width dimension of tooth shoes of two middle teeth.

In some embodiments, in the 6-tooth comb-shaped lamination 10312, outer side edges of teeth adjacent to the two outer teeth on opposite sides are inclined inward by 15-30 degrees.

In the present embodiment, in the 6-tooth comb-shaped lamination 10312, the outer side edges of teeth adjacent to the two outer teeth on opposite sides are inclined inward by 15-30 degrees. Compared to directly extending connecting shafts from the iron core 1031 of the armature 103, this configuration causes the main body of the armature 103 to be further away from the connecting shafts, and the degree to which the connecting shafts weaken the magnetic field generated by the coils 1032 is significantly reduced. When applied to an electric toothbrush, this can effectively improve battery life.

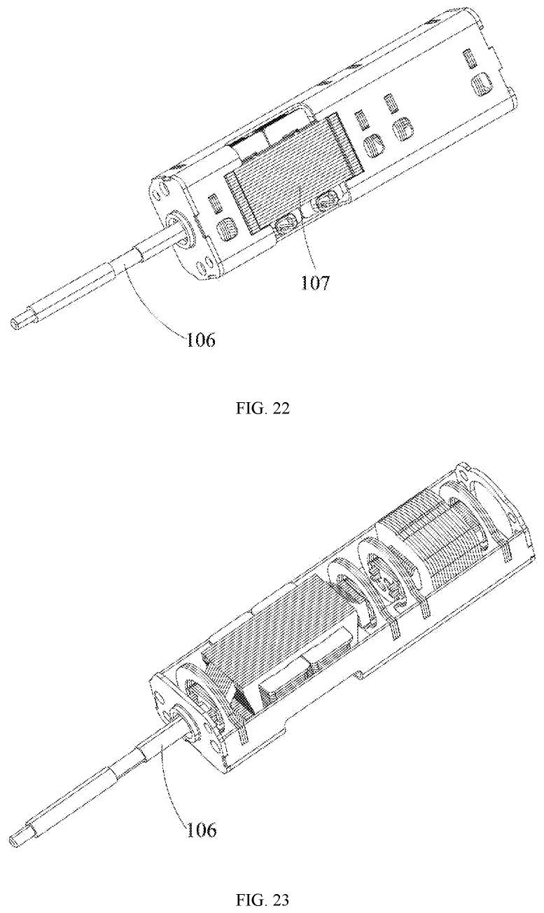

In some embodiments, the permanent magnet assembly 102 comprises three permanent magnets spaced apart on the motor housing, and at an initial position, a first magnet is located between a first tooth and a second tooth of the 4-tooth comb-shaped lamination 10311, a second magnet is located between the second tooth and a third tooth of the 4-tooth comb-shaped lamination 10311, and a third magnet is located between the third tooth and a fourth tooth of the 4-tooth comb-shaped lamination 10311. In addition, an iron piece assembly 107 is provided on a back side of the permanent magnet assembly 102, as shown in FIG. 22. The iron piece assembly 107 is directly fixed to the motor housing. Providing the iron piece assembly 107 can reduce magnetic flux leakage.

In the present embodiment, referring to FIG. 20, the permanent magnet assembly 102 comprises three permanent magnets spaced apart on the motor housing, and at an initial position, the first magnet is located between the first tooth and the second tooth of the 4-tooth comb-shaped lamination, the second magnet is located between the second tooth and the third tooth of the 4-tooth comb-shaped lamination 10311, and the third magnet is located between the third tooth and the fourth tooth of the 4-tooth comb-shaped lamination 10311. The second tooth and the third tooth are provided with coil 1032 windings. The aforementioned winding configuration of the coils 1032 causes virtual magnetic poles to be formed at the ends of the first, second, third, and fourth teeth in an alternating N-pole and S-pole pattern. For example, the ends of the first, second, third, and fourth teeth sequentially form N-pole, S-pole, N-pole, S-pole, or S-pole, N-pole, S-pole, N-pole. When alternating current is applied to the linear high-frequency oscillator, the end faces of the two sets of coil 1032 winding modules facing the permanent magnets alternately form N-pole and S-pole changes. According to the principle of like poles repelling and unlike poles attracting, attraction and repulsion phenomena occur between the permanent magnets and the two sets of coil 1032 winding modules (for example, when two magnets of like poles approach each other, a repulsive force pushes them apart, while two magnets of unlike poles attract and approach each other). This causes the two sets of coil 1032 winding modules to simultaneously apply substantially equal repulsive or attractive forces to both sides of the mover module along the width direction of the motor housing, thereby enhancing the electromagnetic response and balancing the forces on the mover module in the width direction of the motor housing. This avoids displacement of the mover module along the width direction of the motor housing, ensures structural stability, and increases the motor impedance of the linear high-frequency oscillator within a limited space, reducing the operating current of the linear high-frequency oscillator, thereby reducing the power consumption of the linear high-frequency oscillator. Consequently, the battery life of the linear high-frequency oscillator can be extended without increasing the battery capacity. Furthermore, in combination with the deformation and elastic restoring force of the two sets of leaf spring assemblies, reciprocating oscillation output along the axial direction is achieved without easily generating oscillation consumption along the width direction of the motor housing, thereby achieving stable reciprocating oscillation output along the axial direction while reducing excess power consumption of the linear high-frequency oscillator, improving both the battery life of products equipped with the linear high-frequency oscillator and the customer experience.

In some embodiments, the overall shape of the 4-tooth comb-shaped lamination 10311 is an inverted trapezoid, and the 6-tooth comb-shaped lamination 10312 is formed by extending the 4-tooth comb-shaped lamination 10311 outward to connect one additional tooth on each side.

In some embodiments, a height ratio of two outer teeth to four middle teeth of the 6-tooth comb-shaped lamination 10312 is between 1:2 and 1:3.

In the present embodiment, the leaf springs 104 are connected to the two outer teeth on opposite sides of the 6-tooth comb-shaped lamination 10312. When applied to an electric toothbrush, the drive shaft 106 is connected to the central end 1041 of the leaf spring 104, as shown in FIG. 22 or FIG. 23. A height ratio of two outer teeth to four middle teeth of the 6-tooth comb-shaped lamination 10312 is between 1:2 and 1:3. The advantages of this configuration include at least one of the following: with such a proportion, the drive shaft 106 is closest to or substantially at the center of the armature 103. Since the thickness of the permanent magnets is relatively small compared to the armature 103, the drive shaft 106 being close to the center of the armature 103 is approximately close to the center of the linear motor assembly. When this proportional relationship is applied to an electric cleaning device such as an electric toothbrush, the linear motor assembly is arranged in the center of the motor housing 101 of the electric toothbrush, and the drive shaft 106 is approximately at the central axis of the toothbrush, resulting in a well-proportioned overall design with a favorable center of gravity, reducing the vibration sensation caused by oscillation during product use and improving the user experience.

In some embodiments, the leaf spring 104 has a central end 1041 and an outer end 1042, and spirals at least one turn from the central end 1041 to the outer end 1042. The outer end 1042 has two outer connecting ends 10421 forming an angle of 80-100 degrees with respect to the center of the spiral. When the leaf spring 104 is connected to the motor housing 101, the outer connecting ends 10421 are respectively connected to a bottom wall and a side wall of the motor housing 101.

In the present embodiment, since the armature 103 is connected at the central ends 1041 of two leaf springs 104, the aforementioned configuration of two outer connecting ends 10421 at the outer end 1042 causes the armature 103 to form a 4-point connecting structure with four outer connecting ends 10421. If the outer end 1042 had only one outer connecting end 10421, the armature 103 would have a 2-point connecting structure, which would have significantly worse stability than the aforementioned 4-point connecting structure.

In some embodiments, the motor housing 101 is trough-shaped, with a front end provided with a through hole for the drive shaft 106 to pass through and connect to the leaf spring 104.

Obviously, the above-described embodiments are only some, but not all, embodiments of the present disclosure. The drawings show preferred embodiments of the present disclosure, but do not limit the scope of the present disclosure. The present disclosure can be implemented in many different forms. On the contrary, these embodiments are provided to facilitate a more thorough and comprehensive understanding of the present disclosure. Although the present disclosure has been described in detail with reference to the foregoing embodiments, those skilled in the art can still modify the technical solutions described in the foregoing specific embodiments or replace some of the technical features with equivalents. Any equivalent structure that makes direct or indirect use of the content of the description and drawings of the present disclosure in other related technical fields is also within the scope of the present disclosure.

What is claimed is:

1. A brush head assembly for an oral cleaning device, comprising an outer side configured for connection to a functional element and an inner side provided with a movable disk, wherein the movable disk is provided with a mating area offset from a center of the brush head assembly and a rotating shaft located at the center of the brush head assembly, and the mating area is an elliptical groove or a fixing rod arranged on the movable disk.

2. The brush head assembly according to claim 1, wherein the movable disk has a cam shape, the mating area is arranged at an acute-angled end of the cam shape, and a side of a rounded end of the cam shape is provided with a longitudinally-opened receiving slot.

3. The brush head assembly according to claim 1, wherein an orthographic projection of the movable disk is composed of two circular segments sharing a common chord, a distance between a central point of the elliptical groove and a central point of the brush head assembly is equal to a distance between the central point of the brush head assembly and an edge on another side of the movable disk, or a distance between the central point of the elliptical groove and the central point of the brush head assembly is slightly greater than the distance between the central point of the brush head assembly and the edge on the other side of the movable disk.

4. A transmission structure for an oral cleaning device, comprising:
a brush head assembly having an outer side configured for connection to a functional element and an inner side provided with a movable disk, the movable disk being provided with a mating area offset from a center of the brush head assembly and a rotating shaft located at the center of the brush head assembly; and
a motion-transmitting member including an input end connected to a transmission mechanism of the oral cleaning device and an output end adapted to the mating area, the output end being eccentrically arranged relative to a longitudinal axis of the input end;
wherein, when the transmission mechanism drives the motion-transmitting member, the output end reciprocates with a variable diameter relative to a center of the movable disk, and the mating area drives the brush head assembly to oscillate reciprocally; and
a maximum longitudinal reciprocating travel of the motion-transmitting member is 1-5 mm.

5. The transmission structure according to claim 4, wherein the mating area is an elliptical groove, the output end is a guide rod, and the guide rod is adaptively connected to the elliptical groove; or
the mating area is a fixing rod arranged on the movable disk, the output end is a pivot hole, and the fixing rod is adaptively connected to the pivot hole.

6. The transmission structure according to claim 5, wherein the movable disk has a cam shape, the mating area is arranged at an acute-angled end of the cam shape, and a side of a rounded end of the cam shape is provided with a longitudinally-opened receiving slot.

7. The transmission structure according to claim 4, wherein a magnetic attraction force of the input end of the motion-transmitting member is between 3.5 N and 35 N.

8. The transmission structure according to claim 5, wherein a length of the elliptical groove is 2 mm, and a distance between the guide rod and the center of the brush head assembly is 2 mm to 4 mm.

9. The transmission structure according to claim 5, wherein a shortest distance between a center point of the guide rod and a central axis of the input end is 1.5-4.5 mm.

10. The transmission structure according to claim 4, wherein a maximum longitudinal reciprocating travel of the motion-transmitting member is 1.5 mm-3.5 mm, and a rotation angle of the brush head assembly is between −38° and 38°.

11. The transmission structure according to claim 4, wherein at least the input end of the motion-transmitting member is integrally formed.

12. An oral cleaning device, comprising: a housing, a motion-transmitting member, and a brush head assembly, the motion-transmitting member being arranged inside the housing;
wherein the brush head assembly is rotatably connected to an end of the housing, a functional element is arranged on one side of the brush head assembly, a movable disk is arranged on another side of the brush head assembly, the movable disk is provided with a mating area offset from a center of the brush head assembly; the motion-transmitting member includes an input end connected to a transmission mechanism of the oral cleaning device and an output end adapted to the mating area, the output end is eccentrically arranged relative to a longitudinal axis of the input end; the output end of the motion-transmitting member is matched with the mating area, and when the output end reciprocates longitudinally, the mating area and the brush head assembly are driven to oscillate reciprocally.

13. The oral cleaning device according to claim 12, wherein the input end is integrally formed, the output end is a guide rod or a pivot hole adapted to the mating area, and a connecting rod connects the guide rod or the pivot hole with the input end; a shortest distance between a center point of the guide rod and a central axis of the input end is 1.5-4.5 mm, and a distance between the guide rod and the center of the brush head assembly is 2 mm-4 mm.

14. The oral cleaning device according to claim 13, wherein the oral cleaning device further includes a handle, the handle being connected to a lower end of the housing, a transmission mechanism and a motor being arranged inside the handle, an output end of the motor being connected to an input end of the transmission mechanism, a battery being further arranged inside the handle, the battery being disposed at a lower end of the motor and electrically connected to the motor;
the transmission mechanism includes a driving gear, a driven gear, and a transmission rod, the driving gear is sleeved on an output shaft of the motor, the motor is fixedly connected to an inner wall of the handle, the output shaft of the motor is arranged upward along a length direction of the handle, the driving gear is horizontally and rotatably connected to the output shaft of the motor, the driven gear is a bevel gear, the driven gear and the driving gear are perpendicular to each other, the driven gear meshes with the driving gear, the transmission rod is transmission-connected to the driven gear, the motor drives the driving gear to rotate horizontally and drives the driven gear to rotate vertically, and the driven gear drives the transmission rod to reciprocate up and down.

15. The oral cleaning device according to claim 12, wherein the transmission mechanism has a magnetic connecting portion, and a magnetic attraction force between the input end of the motion-transmitting member and the magnetic connecting portion is between 3.5 N and 35 N.

16. The oral cleaning device according to claim 12, wherein the oral cleaning device further includes a handle, the handle being connected to a lower end of the housing, a linear motor assembly and an output shaft being arranged inside the handle, a battery being further arranged inside the handle, the battery being disposed at a lower end of the linear motor assembly and electrically connected to the linear motor assembly;
the linear motor assembly includes:
a motor housing;
a permanent magnet assembly, the permanent magnet assembly being at least two permanent magnets spaced apart on the motor housing, the permanent magnet assembly serving as a stator;
an armature, an iron core of the armature having two sets of coils connected in series and arranged along an axial direction, both ends of the iron core being connected to the motor housing via leaf springs and positioned above the permanent magnet assembly, the armature serving as a mover;
wherein the transmission mechanism is the output shaft connected to the armature;
a gap between the permanent magnets and comb-tooth portions of the iron core of the armature is set between 0.1 mm and 0.8 mm.

17. The oral cleaning device according to claim 16, wherein the oral cleaning device further includes: an auxiliary module formed by a counterweight having both ends connected to the motor housing via leaf springs;
a back side of the permanent magnet assembly is provided with an iron piece assembly, the iron piece assembly being fixed to the motor housing;
the leaf spring has a central end and an outer end, and spirals at least one turn from the central end to the outer end, the outer end having at least two outer connecting ends forming an angle of 80-100 degrees with respect to a center of the spiral, and when the leaf spring is connected to the motor housing, the at least two outer connecting ends are respectively connected to a bottom wall and a side wall of the motor housing;
the permanent magnet assembly comprises three permanent magnets spaced apart on the motor housing, and the number of the outer connecting ends is two.

18. The oral cleaning device according to claim 17, wherein a main body of the iron core of the armature is formed by mixed stacking of 4-tooth comb-shaped laminations and 6-tooth comb-shaped laminations, and two sets of coils are wound around two central teeth; laminations for connecting the leaf springs are 6-tooth comb-shaped, with two outer teeth on opposite sides being shorter, and at least a portion of the outer surfaces of the two outer teeth on opposite sides being provided with connecting lugs.

19. The oral cleaning device according to claim 18, wherein in the 6-tooth comb-shaped lamination, tooth shoes of a second tooth and a fifth tooth are equal to half a width dimension of tooth shoes of two middle teeth.

20. The oral cleaning device according to claim 18, wherein the permanent magnet assembly comprises three permanent magnets spaced apart on the motor housing, and at an initial position, a first magnet is located between a first tooth and a second tooth of the 4-tooth comb-shaped lamination, a second magnet is located between the second tooth and a third tooth of the 4-tooth comb-shaped lamination, and a third magnet is located between the third tooth and a fourth tooth of the 4-tooth comb-shaped lamination.
